(19) United States
(12) Patent Application Publication
(10) Pub. No.: US 2007/0028111 A1
(43) Pub. Date: Feb. 1, 2007

(54) Methods and apparatus for authentication of content delivery and playback applications

(76) Inventor: Fred Covely, Vista, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/480,342

(22) Filed: Jun. 30, 2006

Related U.S. Application Data
(60) Provisional application No. 60/696,137, filed on Jul. 1, 2005.

(51) Int. Cl. H04L 9/00

(52) U.S. Cl. 713/176

(57) ABSTRACT

A method is provided to notify or indicate to an end user of a computing device that a payload that is being viewed or listened to is in fact from a trusted source. A media signature, such as visual, audio, and/or tactile signature is selected by a user. When a user computer accesses remote content, a content authentication is performed. If the content is authenticated, then the media signature is retrieved and displayed or played back to the user in association with the content.

### PRIORITY CLAIM

This application claims priority from U.S. patent application Ser. No. 60/696137, filed Jul. 1, 2005, the contents of which are incorporated herein in their entirety.

### BACKGROUND OF THE INVENTION

1. Field of the Invention

The present invention relates to methods and systems for authentication, and in particular, to methods and systems for authentication of content delivery.

2. Description of the Related Art

With the great increase in online transactions, there has been a commensurate increase in related fraudulent activities. For example, criminals may attempt to fraudulently acquire critical information, such as passwords, financial account numbers, contact information, and the like, by providing official-looking electronic communications (e.g., an email, instant message, or Web page) that pretends to be from a trustworthy entity, such as a government entity, a bank, or a large online retail establishment. Such fraudulent communications typically ask a consumer to provide sensitive information, such as account passwords, credit card numbers, and so on.

Such fraudulent activities have an adverse affect on consumers' willingness to participate in online transaction.

### SUMMARY OF THE INVENTION

Example embodiments described herein provide authentication of digital data and content via secure visual, auditory, and/or tactile feedback mechanisms. The authentication provides verification that electronic content a user is viewing and/or hearing via a computing device is from the source that the content purports to be from.

One embodiment includes program code stored in computer readable memory, the program code configured to: provide a user interface for display on a display associated with a computing device, via which a user can select media to be used in a private media signature; monitor content received over a network or from storage media associated with the computing device for authentication information; determine whether the content is authentic; access the private media signature via the computing device, wherein the private media signature includes the user selected media; and in association with the content, automatically provide the private media signature.

One embodiment provides a method of authenticating content, the method comprising: providing a user interface for display on a display associated with a computing device, via which a user can select media to be used in a private media signature; receiving a user media selection; storing the private media signature; monitoring content received over a network or from storage media associated with the computing device for authentication information; determining whether the content is authentic; accessing the private media signature; and providing the user with the private media signature in association with the content.

One embodiment includes program code stored in computer readable memory, the program code configured to: provide a user interface for display on a display associated with a computing device, via which a user can select media to be used in a private media signature; access the private media signature via the computing device, wherein the private media signature includes the user selected media; receive an indication as to the authenticity of content received by the computing device from a content provider; and if the indication indicates that the content is authentic, automatically provide the user with the private media signature in association with the content.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example end user device used to provide authentication of content.

FIG. 2 illustrates example digital certificate processing.

FIG. 3 illustrates an example authentication process that does not require the use of a digital certificate.

### DETAILED DESCRIPTION OF PREFERRED EMBODIMENTS

Multiple methods and technologies exist for securing communications over computer networks. Secure sockets, digital certificates, and other industry standard methods for validating content in a computer to computer exchange are ubiquitous in computer systems world wide. These conventional systems often presume that the actual display or rendering of either images, audio, and by extension other media types (tactile) is already secure and uncompromised. Thus, a computer may make a connection to a secure server computer and identify the server using a digital certificate. The two computers may send data using Secure Sockets (SSL), resulting in a relatively secure means of sending data between two computers.

What has been largely overlooked or ignored is the desirability of providing an end user the ability to perceive that a document, email, or other data is in fact what it appears to be and is being provided by the entity that appears to be providing the data. This weakness has been exploited by malicious users to present documents (either email or web based) that appear to be from a specific, trusted source (such as a bank, other financial institution, a retail establishment, a government entity, etc.), but that are in fact from the malicious party.

For example, a user may be directed to a web site that appears exactly as the legitimate web site, where the user (unaware that the site is not legitimate) is directed to enter in the user's private passwords, credit card numbers, or other information that may then be used to commit fraud by the malicious party. Such attacks have come to be known as ‘phishing’.

However, phishing is a variant of a more general attack which relies on the fact that the presentation of data or media in general is not secure.

The following examples will illustrate the more general problem.

In a first example of a phishing attack, a user's computer has been compromised by malicious software. The malicious code intercepts HTTP (Hypertext transfer protocol) requests and watches for URLs (Uniform Resource Locators) that go to financial sites. When the malicious code detects that the user has gone (for example) to his bank's login page, the code then executes the following actions, not observable to the user:

1) A bitmap file is displayed which looks exactly like the user's browser in that the navigation bar, menu bar, status bar, and other components of the browser software itself are displayed as a bitmap.

2) Also within the bitmap is an image which looks exactly like the user's banking login page.

3) The ‘real’ browser window is made invisible

4) The bitmap is displayed

5) The user enters his user name and password on the bitmap.

6) The user name and password is captured by the malicious software for later transmission

7) The malicious software transfers the legitimate username and password to the ‘real’ hidden browser and performs through the ‘real’ browser a login.

8) The malicious software redisplays the original ‘real’ browser and hides, and then removes the fake bitmap

9) The user proceeds as normal to interact with his/her banking site.

With respect to the above example, first the user may have received visual feedback, via a little yellow lock icon, or similar security symbol, in the browser (and emulated in the fake bitmap) which lead the user to believe that they were on the ‘real’ bank web site. Thus, because a sufficiently secure visual feedback mechanism is provided in conventional systems, the user's perception was that the transaction was secure, wherein the little lock icon induces a false sense of security. Another observation is if a graphic (e.g., an icon, pattern, logo) is known to the bank and used for all banking transactions with all users, then malicious entities likewise become aware of the graphic, and thus the graphic could be copied and used maliciously. If the user computer has the malicious software discussed above, even if a bank could authenticate the user and display an identifying graphic (even one known only to the user), the malicious software running on the user computer could copy the graphic and incorporate it into a fake bitmap for later use.

The same general principals of the above example phishing attack can be applied to legal document received as for example an encrypted PDF document. A malicious program on the end user's computer could detect the launch of a PDF document reader. Once detected, the malicious program could launch a bitmap image that looked somewhat like the real document, but had key information changed to the attacker's advantage. Again, in this example, the end user needs positive sensory feedback that the document being viewed is in fact being displayed without compromise, as the originator intended.

Other variations of the above attacks may be envisioned in telephony, instant messaging, custom applications software, automated teller machines (ATM), etc.

In summary, many of these conventional systems are inadequate in their ability to send and authenticate data at a system level and to then convey to the user in a secure manner that what they are viewing or listening to is in fact authentic.

To overcome flaws in existing authentication mechanisms, in one embodiment a method is provided to notify or indicate to an end user of a computing device that a payload that is being viewed or listened to is in fact from a trusted source.

With respect to the description herein, unless otherwise indicated, the functions described herein are preferably performed by software including executable code and instructions running on one or more general-purpose computers. The computers can include one or more central processing units (CPUs) that execute program code and process data, memory, including one or more of volatile memory, such as random access memory (RAM) for temporarily storing data and data structures during program execution, non-volatile memory, such as a hard disc drive, optical drive, or FLASH drive, for storing programs and data, including databases, which may be referred to as a “system database,” and a network interface for accessing an intranet and/or Internet. In addition, the computers can include one or more speakers, a display for displaying user interfaces, data, and the like, and one or more user input devices, such as a keyboard, mouse, pointing device, microphone and/or the like, used to navigate, provide commands, enter information, provide search queries, and/or the like. However, the present invention can also be implemented using special purpose computers, terminals, state machines, and/or hardwired electronic circuits. In addition, the example processes described herein do not necessarily have to be performed in the described sequence, and not all states have to be reached or performed.

The term, computing device, as used herein can include, by way of example and not limitation, a personal computer, laptop computer, cell phone, personal digital assistant, hand held computing device, intelligent or interactive television, smart phone, personal media player, hand held media player, or other processor-based device.

The term payload, as used herein, can include, by way of example and not limitation, a variety of content, such as digital data, HTML documents, other types of Web pages, other digital documents, database records, voice, interactive or recorded digital audio, images, and/or video, or other types of data and documents in an electronic format, including those that are transmitted or used by computing devices.

In one embodiment, the authentication of the payload is performed via conventional, unconventional, or yet to be developed digital security techniques.

An end user can select authentication content to be used as a private media signature. The authentication content can act as the end user's identifying content signature, to be played back by the system to the end user when the system has authenticated a payload received by the user's computing or telephony device, or other authentication content playback device. Because the end user's selection can be private, it would be difficult for a malicious actor to copy or duplicate the authentication content. Optionally, the system plays back the user's private media signature when the system has authenticated a specific payload as being from a trusted source.

By way of example and not limitation, the authentication content can include audio, video, and/or tactile content. By way of example and not limitation, the video content can include one or more of digital movies, digital pictures/photographs, bitmap files, video recordings, mpeg files, QuickTime files, FLASH files, animation files, etc. that can be played on a terminal, such as a computing device, and viewed by a human. By way of further example and not limitation, audio content can include including analog audio recordings, digital audio recording, sound clips, sound bites, digitized real time voice conversations, such as occur during telephone conversations, mp3 files, wav files, synthesized sounds/voices, etc. By way of still further example and not limitation, the tactile content can include a tactile feedback instruction or a sequence of tactile feedback instructions that can be played back by a tactile playback device. By way of example, a tactile playback device can include one or more input and/or output devices coupled to or including a computer device, wherein the input/output device are configured to provide tactile feedback to a user. For example, some computer game controllers, touch screens, hand controllers, glove controllers, force feedback units, and the like, can provide tactile playback.

An embodiment of a system that stores authentication content may also include a program or device (e.g., a third party program or device) that can utilize the private media signature chosen by the user when the program or device has authenticated a communication, document, data, or media file that the user is viewing, or listening to.

Optionally, the system provides an application programming interface that allows a trusted third party computer program to access the features of the system, thus allowing the third party program to playback the user's private media playback signature when the third party application has authenticated a payload (e.g., using conventional or unconventional payload authentication techniques).

Optionally, the system described herein includes an encryption/decryption program that can encrypt and decrypt the private media signature and playback/display the private media signature on the user's computing device when the system has authenticated a payload using a digital signature embedded in or associated with the payload.

The user's private media signature may be determined using one or more of the following processes.

A preferences user interface is displayed on a computing device display. The user interface includes fields and/or a drop down menu via which the user can select a preferred authentication type (e.g., audio visual, tactile). The user selection is stored in non-volatile memory.

The software then presents to the user, via the computing device display, a list indicating the user's preference of audio, visual, or tactile feedback as the chosen mechanism of the playback of the private media signature. Based on the user's selection, the user is presented with a list, and possibly a very large list, of optional media files from which to choose. The user selects a file. The identity of the selected file is known only to the user (and to those to which the user discloses the file identity). The selected file is then optionally encrypted by the software and stored in nonvolatile memory.

In yet another embodiment, the user's choice of private media signature is determined using a secure software application, which application includes a user interface that queries the user as to the user's preference of specific visual content, audio content, or tactile content, which the system will then employ as the user's private media signature.

Another embodiment provides a user interface including a field configured to receive a user entered text password. The password is the converted into non-machine readable private media signature consisting of visual content, or audio content, by way of example.

In yet another embodiment, the private media signature is generated randomly (wherein the term randomly all includes pseudo-random. private media signature generation).

In another embodiment, the user may optionally type in a password into a user interface, which is then converted to non-computer readable bitmap image, or a spoken audio sequence.

Optionally, an embodiment enables the user to create a private media signature by capturing video images using digital camera or digital movie recorder, or by capturing an audio signal (e.g., music, spoken sounds, mechanical created sounds, etc.) via a microphone coupled to the computing device or a dedicated audio recorder, and storing the audio signal on tape, magnetic memory, solid state memory, or other memory. By way of example, a user can capture images/pictures of the user's family members or a clip from a favorite movie, using a digital camera, or the user can use audio recording to capture a favorite audio song or part thereof.

A further embodiment has the system generate a private media signature by allowing the user to use a computing device to select a specific instance of authentication content from a library or database of authentication content consisting of images, audio clips, and other authentication content.

The selected authentication content is digitally encrypted and the encrypted authentication content is stored on the end user's computing device.

In an embodiment, a content provider (e.g., a provider of digital data, HTML documents, other types of Web pages, other digital documents, database records, voice, interactive or recorded digital audio, images, and/or video, and/or documents in an electronic format) embeds a digital signature in the payload. A private key is used in the digital signature in the payload. The digital signature is optionally obtained electronically over a network from a central server from which the client portion of the system under discussion retrieves the corresponding public key. The public key is then used to decrypt the digital signature in or associated with the payload on the user's computing device. If the decryption is successful, the system running on the client computing device decrypts and playbacks the user's own personal private media playback signature, thus informing the user via visual, auditory, and/or tactile feedback that the document being viewed is in fact from a trusted source.

In a further embodiment, a payload is authenticated by using an identifying digital signature and/or other cryptographic data within, preceding, or following the payload in a network, or file data stream.

An embodiment optionally enables a third party content provider to embed a digital signature in the payload, which signature is received by the system on the client's computing device. The signature is then resent by the system back to a centrally located server which validates the digital signature and sends back a response to the system on the client indicating that whether the payload is authentic or not. Optionally, in addition or instead, the digital signature in the payload is validated by the system on the client computing device.

Another embodiment includes a specific sequence of data (e.g., of bytes) in the payload that would constitute an ‘eye catcher’ to client software monitoring data on a computing device. The eye catcher is used to efficiently identify content originating from a content provider that is using the system.

Optionally, steganographic messages or other identifiers or included in or associated with the payload, instead of, or in conjunction with a digital signature.

Optionally, software executing on the user's computing device examines the content data stream for other encrypted signatures, which the system can compare to known signatures in order to authenticate the content. Again, on authentication, the private media playback signature is played back to the user.

Other techniques can be used to authenticate a payload wherein the authentication leads to the playback to the client of a private media signature.

Optionally, the user is offered the option of categorizing content, data, or media providers in a security hierarchy, such that each group of providers displays a single, unique private media signature of the user's choosing.

In yet another embodiment, a user's private media playback signature is used in conjunction with Automated Teller Machines (ATM's), credit card payment terminals, or the like, to read the user's private media playback signature off of a solid state, magnetic, or optical storage media coupled to a financial instrument, such as a credit card, debit card, or other magnetic media using an appropriate reader or scanner. The private media signature is then played back to the user through or in conjunction with the ATM machine or credit card payment terminal.

In an embodiment, the software program is used to playback a private media playback signature to thereby validate that a user is on a website the user believes he is on.

By providing the above authentication and private media signature, the software program can be used to provide an anti-phishing system.

In a further embodiment, the program is used to playback a private media playback signature when an email program is displaying an email from an email sender, the content of which has been verified by the program to be from the sender the recipient of the email believes it is from.

The software program is optionally used to playback a private media playback signature when a real time voice connection is made with a another person on phone, cell phone, or IP based phone, wherein the originator of the call has been verified by the program to be from the originator the recipient of the call believes it is from.

The user may use multiple media playback signatures known only to the end user, to represent different security groups of typically high, medium, and low risk, or other groupings preferred by the user.

Optionally, the entire system is configured and managed by an implementer. In one embodiment, there are three distinct phases of using the system: 1) User sign up, 2) Content provider sign up, 3) run time authentication and notification.

Client setup and private media signature selection will now be described. In an example embodiment, a web browser based application program running on a public server as managed by the implementer, performs the action of signing the user up to use the system by downloading to a user computing device the client side program in response to a user request (e.g., provided by clicking on a link or other control). In an example embodiment, the client side program is a browser plug-in that runs on the client computing device. In another example embodiment, the client side program is an operating system plug-in that runs on the client computing device. In still another embodiment, the client side program is an application program that runs on the client computing device.

In an example embodiment, once the client side software is executing on the user's computing device, the user is directed via a web browser or other application to a central server where a user interface is presented to the user with a user name field and a password field. The user enters a user name and password, and the type of private media signature to use, (e.g. visual, audio, tactile, etc.).

Once the user selects one or more of the preferred types of private media signatures, the user is presented with a list (potentially a large list) of specific instances of visual, audio, or tactile content, as appropriate. The visual content may be bitmap images, a JPEG file, a video recording clip, etc. Similarly, if the user has selected audio content as one of the user's types of private media signature, then the user will be given a selection form a pool of audio clips from which to choose one, wherein the pool can be small, medium, or large in size.

Via a categorization user interface, the user may categorize private media signatures into groups, such as: ‘Financial websites’, ‘Email’, “Online Retailers”, “Online Service Providers”, “Music Downloads”, “Movie Downloads”, and/or other categories. The system then will playback or display the private media signature appropriate for the category of content being viewed or listened to.

Optionally, the private media signatures selected by the user as the user's own unique identifying private media signatures, are then encrypted into a file, optionally using a user entered password as an encryption key. Once the user's private media signature has been entered, it is stored on the client computing device, optionally in an encrypted form.

An example content provider setup process will now be described.

In an example scenario, a provider of data, content, or multimedia, obtains a private key from the implementer. In this example embodiment, the implementer also acts as a certificate authority so that client users of the system may retrieve the matching public key via a digital certificate. The public key issued by the implementer is known only to the content vendor, the implementer, or other appropriate party. In an example embodiment, the content provider may, in an automated fashion, request and obtain as many private keys as needed from the implementer using a web service or other form of automation. The content provider then optionally uses the private key to construct digital signatures for use in documents sent to client computing devices.

The content provider may optionally provide a text eye catcher (e.g., a clear text eye catcher) that the software on the client computing device will use to identify a document or input stream that can potentially be validated at run time via a digital signature.

Example processes for run time authentication and playback of the private media signature will now be described.

In an example embodiment, a software program running on a client computing device monitors or intercepts documents, media, or other electronic communications received by the client computing device over a network or via solid state, magnetic, and/or optical media. The software program monitors the various incoming documents or media files, looking for an eye catcher unique to the system that was sent in a document transmitted by a content provider. The eye catcher notifies the software program on the client that a document potentially is secure.

In an example embodiment, the software program examines the incoming document for a digital signature and attempts to decrypt it using an appropriate public key. If the decryption is successful, the document is considered validated.

In an example embodiment, once the system has authenticated a document it then reads the user's encrypted private media signature from of a local storage device. The private media signature is decrypted and the decrypted private media signature is then played back using a corresponding play back mechanism: visually on a display, audibly via an audio playback device (which can be the user's computing device), or via a tactile controller.

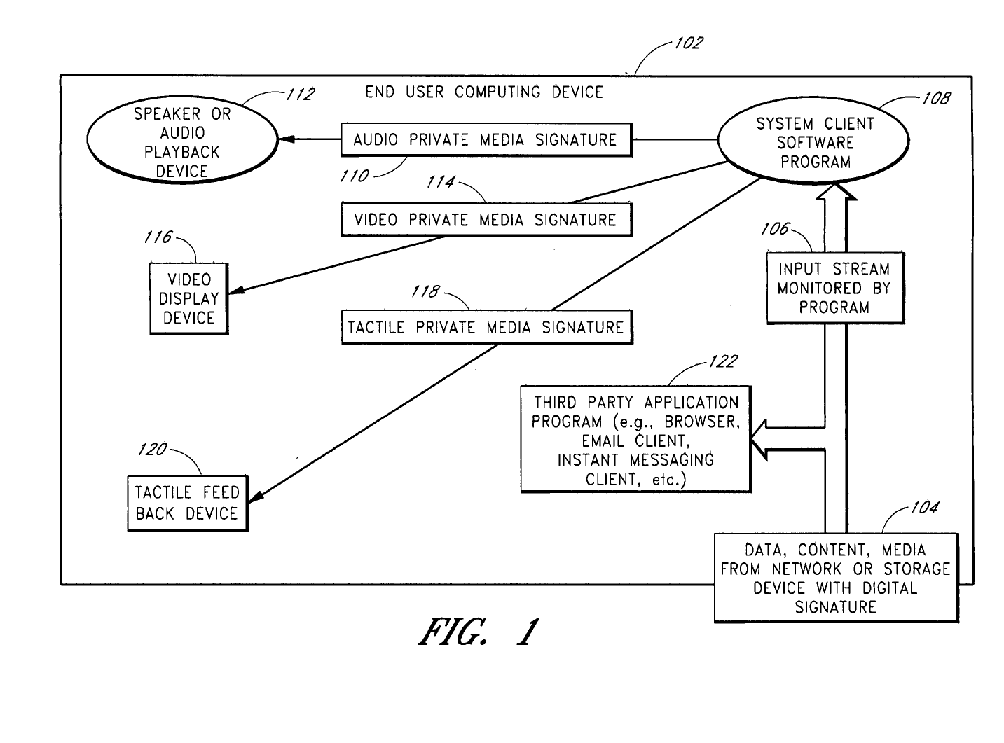

Referring now to the figures, FIG. 1 illustrates an example end user device and process used to provide authentication of content. An end user computing device 102 is provided. Content 104 (e.g., data, programs, media, etc.) is stored on a local storage device (e.g., fixed or user removable solid state, magnetic, or optical memory) or is accessible over a network from a remote storage device or server 104. The content, as it is received by the computing device as an input stream or accessed from computing device memory, is monitored at state 106 by the client software program 108. For example, the client software program can search for encrypted signatures in the content, and if located, compares the signature to known signatures in order to authenticate the content.

Upon authentication, the private media playback signature is played back to the user. For example, an audio media playback signature 110 is played back via a computing device speaker or other audio playback device 112 (such as a telephonic device). A video media playback signature 114 is played back via a video decoder and a display device 116. A tactile media playback signature 118 is played back via a tactile feedback device 120. The client program 108 is optionally used to playback the private media playback signature when another program (e.g., an email client, an instant message client, a browser, etc.) is displaying or playing back the content 104, once the content 104 has been authenticated.

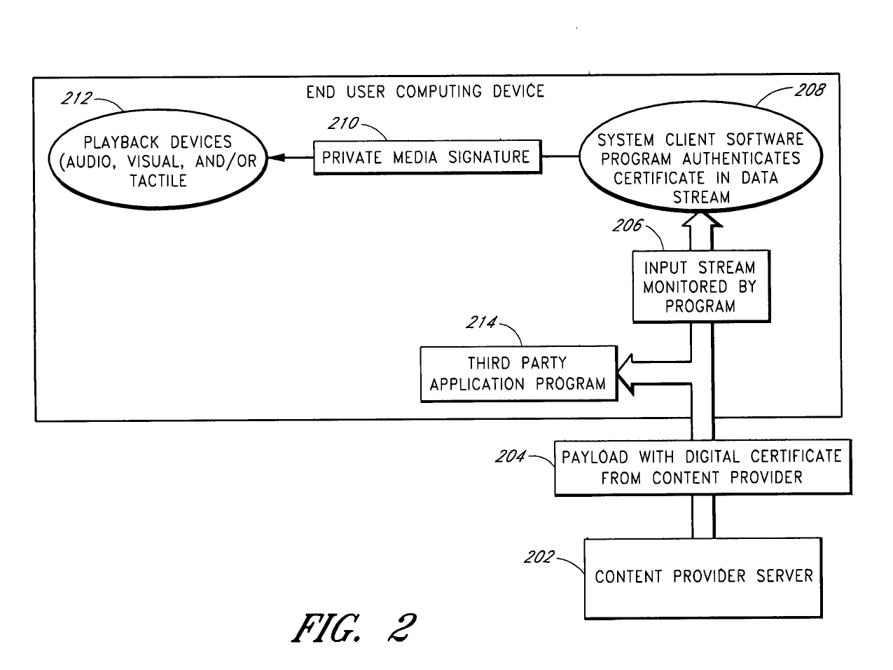

FIG. 2 illustrates example digital certificate processing. A content provider has an associated content provider server 202 that stores content accessible to end user computing devices over a network (e.g., the Internet, an intranet, or other network). By way of example, the server can host a Web site configured to serve Web pages to client devices and/or to provide content downloads of audio data, video data, text date, graphics data, or other data files in response to receiving a corresponding URL and/or in response to a user activating a corresponding control (e.g., a link or other control).

Upon request from an end user computing device (or in a push operation), the server 202 retrieves the requested content from a content database, embeds a digital certificate in the content or associates the digital certificate with the content, and at state 204, streams or otherwise transmits the requested content and digital certificate to the end user computing device. The digital certificate may have been generated by the content provider or another entity using a private key.

At state 206, the system client software 208 monitors the content stream for the digital certificate and if located, authenticates the certificate. If the authentication fails, a failure notification is presented to the user via the computing device display. If the certificate is authenticated (e.g., using a public key accessed over a network from another server), then the private media signature 210 is retrieved from computing device memory, and if encrypted, the signature 210 is decrypted, and provided to the appropriate playback device 212 (e.g., audio, visual, and/or tactile playback device). The client software 208 is optionally used to playback the private media playback signature when another program 214 (e.g., an email client, an instant message client, a browser, etc.) is displaying or playing back the content from the server once the digital certificate has been authenticated.

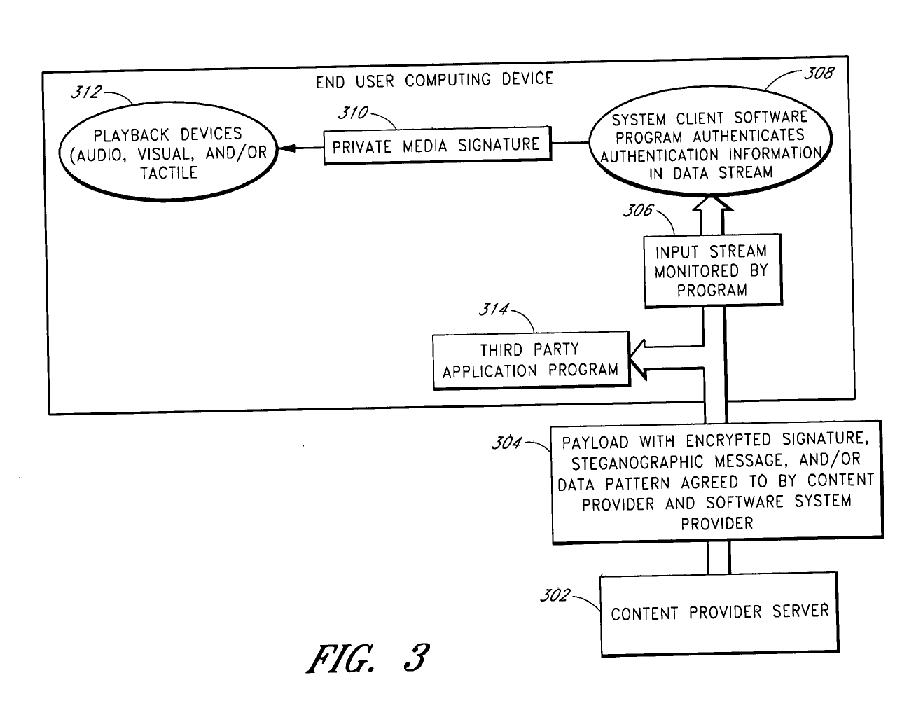

FIG. 3 illustrates an example authentication process that does not require the use of a digital certificate. A content provider has an associated content provider server 302 that stores content accessible to end user computing devices over a network (e.g., the Internet, an intranet, or other network). Upon request from an end user computing device (or in a push operation), the server 302 retrieves the requested content from a content database. At state 304, the server 302 embeds into or associates with the content payload an encrypted signature, a steganographic message, and/or a data pattern agreed to by the content provider the provider of the client software. The server 302 streams or otherwise transmits the payload to the end user computing device.

At state 306, the system client software 308 monitors the content stream for the encrypted signature, a steganographic message, and/or a data pattern, and if located, authenticates the payload. If the authentication fails, a failure notification is presented to the user via the computing device display. If authentication is successful, then the private media signature 310 is retrieved from computing device memory, and if encrypted, the signature 210 is decrypted, and provided to the appropriate playback device 312 (e.g., audio, visual, and/or tactile playback device). The client software 308 is optionally used to playback the private media playback signature when another program 314 (e.g., an email client, an instant message client, a browser, etc.) is displaying or playing back the content from the server once the payload has been authenticated.

It should be understood that certain variations and modifications of this invention would suggest themselves to one of ordinary skill in the art. The scope of the present invention is not to be limited by the illustrations or the foregoing descriptions thereof.

What is claimed is:

1. Program code stored in computer readable memory, the program code configured to:
provide a user interface for display on a display associated with a computing device, via which a user can select media to be used in a private media signature;
monitor content received over a network or from storage media associated with the computing device for authentication information;
determine whether the content is authentic;
access the private media signature via the computing device, wherein the private media signature includes the user selected media; and
in association with the content, automatically provide the private media signature.

2. The program code as defined in claim 1, wherein the media includes audio media.

3. The program code as defined in claim 1, wherein the media includes video media.

4. The program code as defined in claim 1, wherein the media includes tactile media.

5. The program code as defined in claim 1, wherein the program code is further configured to cause the private media signature to be played to the user via a speaker.

6. The program code as defined in claim 1, wherein the program code is further configured to cause the private media signature to be played to the user via a display.

7. The program code as defined in claim 1, wherein the program code is further configured to cause an audio portion of the private media signature to be played to the user via a speaker and an image portion of the private media signature to be displayed to the user via the display.

8. The program code as defined in claim 1, wherein the program code is further configured to cause at least a portion of the private media signature to be provided to the user via a tactile playback device.

9. The program code as defined in claim 1, wherein the program code is further configured to cause at least a portion of the private media signature to be provided to the user via a force feedback device.

10. The program code as defined in claim 1, wherein the program code is further configured to cause the private media signature to be provided to the user via a browser, an email client, and/or an instant messaging client.

11. The program code as defined in claim 1, wherein the program code is further configured to decrypt the accessed private media signature prior to providing the private media signature to the user in association with the content.

12. The program code as defined in claim 1, wherein the authentication information includes a digital signature.

13. The program code as defined in claim 1, wherein the program code is further configured to cause a public key to be accessed in order to determine whether the content is authentic.

14. The program code as defined in claim 1, wherein the authentication information includes a digital certificate.

15. The program code as defined in claim 1, wherein the authentication information includes an encrypted signature.

16. The program code as defined in claim 1, wherein the authentication information includes a steganographic message.

17. The program code as defined in claim 1, wherein the content includes a Web page.

18. The program code as defined in claim 1, wherein the content includes audio data.

19. The program code as defined in claim 1, wherein the content includes video data.

20. The program code as defined in claim 1, wherein the content includes a document.

21. The program code as defined in claim 1, wherein the computing device is a personal computer.

22. The program code as defined in claim 1, wherein the computing device is a telephonic device.

23. The program code as defined in claim 1, wherein the computing device is a networked television.

24. The program code as defined in claim 1, wherein the computing device is an automated teller machine.

25. The program code as defined in claim 1, wherein the computing device is a handheld media player.

26. The program code as defined in claim 1, wherein the program code is further configured to provide a user interface via which the user can associate a first private media signature with a first category of content and a second private media signature with a second category of content.

27. A method of authenticating content, the method comprising:
providing a user interface for display on a display associated with a computing device, via which a user can select media to be used in a private media signature;
receiving a user media selection;
storing the private media signature;
monitoring content received over a network or from storage media associated with the computing device for authentication information;
determining whether the content is authentic;
accessing the private media signature; and
providing the user with the private media signature in association with the content.

28. The method as defined in claim 27, the method further comprising encrypting the private media signature prior to storing the private media signature.

29. The method as defined in claim 27, the method further comprising storing the private media signature on a financial instrument.

30. The method as defined in claim 27, wherein the media includes audio media.

31. The method as defined in claim 27, wherein the media includes video media.

32. The method as defined in claim 27, wherein the media includes tactile media.

33. The method as defined in claim 27, wherein the media includes a home video and/or a photograph.

34. The method as defined in claim 27, the method further comprising causing the private media signature to be played to the user via a speaker.

35. The method as defined in claim 27, the method further comprising causing the private media signature to be played to the user via a phone.

36. The method as defined in claim 27, the method further comprising causing the private media signature to be played to the user via a display.

37. The method as defined in claim 27, the method further comprising causing an audio portion of the private media signature to be played to the user via a speaker and an image portion of the private media signature to be displayed to the user via the display.

38. The method as defined in claim 27, the method further comprising causing at least a portion of the private media signature to be provided to the user via a tactile playback device.

39. The method as defined in claim 27, the method further comprising causing at least a portion of the private media signature to be provided to the user via a force feedback device.

40. The method as defined in claim 27, the method further comprising causing the private media signature to be provided to the user via a browser, an email client, and/or an instant messaging client.

41. The method as defined in claim 27, wherein the method is further configured to decrypt the accessed private media signature prior to providing the private media signature to the user in association with the content.

42. The method as defined in claim 27, wherein the authentication information includes a digital signature.

43. The method as defined in claim 27, the method further comprising causing a public key to be accessed in order to determine whether the content is authentic.

44. The method as defined in claim 27, wherein the authentication information includes a digital certificate.

45. The method as defined in claim 27, wherein the authentication information includes an encrypted signature.

46. The method as defined in claim 27, wherein the authentication information includes a steganographic message.

47. The method as defined in claim 27, wherein the content includes a Web page.

48. The method as defined in claim 27, wherein the content includes audio data.

49. The method as defined in claim 27, wherein the content includes video data.

50. The method as defined in claim 27, wherein the content includes a document.

51. The method as defined in claim 27, wherein the content includes an email.

52. The method as defined in claim 27, wherein the computing device is a personal computer or a networked television.

53. The method as defined in claim 27, wherein the computing device is a telephonic device.

54. The method as defined in claim 27, wherein the computing device is an automated teller machine.

55. The method as defined in claim 27, wherein the computing device is a handheld media player.

56. The method as defined in claim 27, wherein the method is further configured to provide a user interface via which the user can associate a first private media signature with a first category of content and a second private media signature with a second category of content.

57. Program code stored in computer readable memory, the program code configured to:
provide a user interface for display on a display associated with a computing device, via which a user can select media to be used in a private media signature;
access the private media signature via the computing device, wherein the private media signature includes the user selected media;
receive an indication as to the authenticity of content received by the computing device from a content provider; and
if the indication indicates that the content is authentic, automatically provide the user with the private media signature in association with the content.

58. The program code as defined in claim 57, wherein the media includes audio media.

59. The program code as defined in claim 57, wherein the media includes video media.

60. The program code as defined in claim 57, wherein the media includes a digital photograph.

61. The program code as defined in claim 57, wherein the media includes a digital image.

62. The program code as defined in claim 57, wherein the media includes tactile media.

63. The program code as defined in claim 57, wherein the program code is further configured to cause the private media signature to be played to the user via a speaker.

64. The program code as defined in claim 57, wherein the program code is further configured to cause the private media signature to be displayed to the user via a display.

65. The program code as defined in claim 57, wherein the program code is further configured to cause an audio portion of the private media signature to be played to the user via a speaker and an image portion of the private media signature to be displayed to the user via the display.

66. The program code as defined in claim 57, wherein the program code is further configured to cause at least a portion of the private media signature to be provided to the user via a tactile playback device.

67. The program code as defined in claim 57, wherein the program code is further configured to cause at least a portion of the private media signature to be provided to the user via a force feedback device.

68. The program code as defined in claim 57, wherein the program code is further configured to cause the private media signature to be provided to the user via a browser, an email client, and/or an instant messaging client.

69. The program code as defined in claim 57, wherein the program code is further configured to decrypt the accessed private media signature prior to providing the private media signature to the user in association with the content.

70. The program code as defined in claim 57, wherein the authentication indication is derived from a digital signature.

71. The program code as defined in claim 57, wherein the program code is further configured to cause a public key to be accessed in order to determine whether the content is authentic.

72. The program code as defined in claim 57, wherein the authentication indication is derived from a digital certificate.

73. The program code as defined in claim 57, wherein the authentication indication is derived from an encrypted signature.

74. The program code as defined in claim 57, wherein the authentication indication is derived from a steganographic message.

75. The program code as defined in claim 57, wherein the content includes a Web page.

76. The program code as defined in claim 57, wherein the content includes audio data and/or video data.

77. The program code as defined in claim 57, wherein the content includes a document.

78. The program code as defined in claim 57, wherein the computing device is a personal computer.

79. The program code as defined in claim 57, wherein the computing device is a telephonic device or a networked television.

80. The program code as defined in claim 57, wherein the computing device is an automated teller machine.

81. The program code as defined in claim 57, wherein the computing device is a handheld media player.

82. The program code as defined in claim 57, wherein the program code is further configured to provide a user interface via which the user can associate a first private media signature with a first category of content and a second private media signature with a second category of content.
